(19) United States
(12) Patent Application Publication
(10) Pub. No.: US 2026/0187497 A1
(43) Pub. Date: Jul. 2, 2026

(54) TIME-SERIES FORECASTING SYSTEM, DEVICE, AND METHOD

(71) Applicant: LG MANAGEMENT DEVELOPMENT INSTITUTE CO., LTD., Seoul (KR)

(72) Inventors: Jaehoon LEE, Seoul (KR); Hankook LEE, Seoul (KR); Sungik CHOI, Seoul (KR); Sungjun CHO, Seoul (KR); Moontae LEE, Gyeonggi-do (KR); Sungwoo PARK, Seoul (KR)

(21) Appl. No.: 19/546,278

(22) Filed: Feb. 20, 2026

Related U.S. Application Data
(63) Continuation of application No. PCT/KR2025/002154, filed on Feb. 13, 2025.

(30) Foreign Application Priority Data
Feb. 14, 2024 (KR) 10-2024-0021055
Apr. 15, 2024 (KR) 10-2024-0049831

(51) Int. Cl. G06N 5/022; G06N 3/04

(52) U.S. Cl. CPC G06N 5/022; G06N 3/04

(57) ABSTRACT

A system generates prediction data by processing an input sequence segmented along a time axis based on a predetermined period using neural networks. The neural networks comprise a first neural network configured to apply dilated attention to the input sequence segmented along the time axis based on the predetermined period, and a second neural network configured to apply random partition attention to data arranged along a feature axis.

### CROSS-REFERENCE TO RELATED APPLICATIONS

The present application is a continuation of International Patent Application No. PCT/KR2025/002154, filed on Feb. 13, 2025, which claims the priority to and the benefit of Korean Patent Application No. 10-2024-0021055, filed on Feb. 14, 2024, and Korean Patent Application No. 10-2024-0049831, filed on Apr. 15, 2024, in the Korean Intellectual Property Office, the entire disclosures of which are incorporated herein by reference in their entireties.

### BACKGROUND

The present disclosure generally relates to a time-series forecasting system, device, and method. More particularly, some embodiments of the present disclosure relate to a system, device, and method for predicting future data by using data sequentially recorded over time using one or more neural networks.

Time-series data refers to data sequentially recorded over time. A problem of predicting future data by analyzing observed time-series data is referred to as a time-series forecasting problem. Recently, research has been conducted on predicting future information using multivariate time-series data, and as the number of variables may range from hundreds to several millions, algorithms capable of efficiently processing and learning data have become increasingly important. Certain embodiments of the present disclosure aim to provide an efficient and accurate multivariate time-series forecasting system, device, and method.

### RELATED ART DOCUMENT

(Patent Document 1) U.S. Pat. No. 10,956,819 (issued on Mar. 23, 2021)

### SUMMARY

An object of some embodiments of the present disclosure is directed to providing an efficient and accurate multivariate time-series forecasting system, device, and method.

One embodiment of the present disclosure may provide a time-series forecasting system, device, and method that use a neural network.

One embodiment of the present disclosure is directed to providing a system including at least one processor and a memory storing one or more instructions. The at least one processor, by executing the one or more instructions stored in the memory, may generate prediction data by processing an input sequence segmented along time axis using a neural network. In addition, the neural network may include at least one of a first neural network configured to apply dilated attention to the input sequence segmented along time axis and a second neural network configured to apply random partition attention to data arranged along a feature axis. The at least one processor may be configured to determine temporal relationship information of input data using the first neural network, determine feature relationship information of the input data using the second neural network, and generate the prediction data based on the temporal relationship information and the feature relationship information.

In one embodiment, at least one of the first neural network and the second neural network may include a sparse attention module.

In one embodiment, the system may further include a segmentation module configured to partition the input data along time axis to generate one or more segments.

In one embodiment, the first neural network may include at least one of a first multi-head self-attention (MHSA) module configured to extract features between segments in the predetermined period, based on a rearrangement of the input sequence segmented along time axis for each feature and a second MHSA module configured to extract features between periods of segments that are periodically spaced by the predetermined period.

In one embodiment, the predetermined period may be

$$P *= {2}^{⌈ {log}_{2} \sqrt{{N}_{s}} ⌉} \approx \sqrt{{N}_{s}}$$

when the number of segments is N_{S}.

In one embodiment, the system may further include a random partition module configured to randomly partition features of the input data, wherein the second neural network may include a third multi-head self-attention (MHSA) module configured to extract inter-feature dependencies based on a rearrangement of the features of the input data according to an arrangement determined by the random partition module.

One embodiment of the present disclosure is directed to providing a method of generating prediction data, performed by at least one processor, the method may include generating the prediction data by processing an input sequence segmented along time axis using a neural network, wherein the neural network may include a first neural network configured to apply dilated attention to the input sequence segmented along time axis, and a second neural network configured to apply random partition attention to data arranged along a feature axis based on output data of the first neural network.

In one embodiment, the generating of the prediction data may include determining temporal relationship information of input data using the first neural network, determining feature relationship information of the input data using the second neural network, and generating the prediction data based on the temporal relationship information and the feature relationship information.

In one embodiment, at least one of the first neural network and the second neural network may include a sparse attention module.

In one embodiment, the method may further include partitioning the input data along time axis to generate one or more segments.

In one embodiment, the first neural network may include a first multi-head self-attention (MHSA) module configured to extract features between segments in a predetermined period, based on a rearrangement of the input sequence segmented along time axis for each feature, and a second MHSA module configured to extract features between periods of segments that are periodically spaced by the predetermined period.

In one embodiment, the predetermined period may be

$${P}_{*} = {2}^{\vert {log}_{2} \sqrt{{N}_{s}} \vert} \approx \sqrt{{N}_{S}}$$

when the number of segments is N_{S}.

In one embodiment, the method may further include randomly partitioning features of the input data, wherein the second neural network may include a third multi-head self-attention (MHSA) module configured to extract inter-feature dependencies based on a rearrangement of the features of the input data according to an arrangement determined by the random partition module.

One embodiment of the present disclosure may include a program stored on a recording medium to execute the method according to one embodiment of the present disclosure on a computer.

One embodiment of the present disclosure may include a non-transitory computer-readable recording medium recording the program for executing the method according to one embodiment of the present disclosure on a computer.

One embodiment of the present disclosure may include a non-transitory computer-readable recording medium recording a database used in one embodiment of the present disclosure.

### BRIEF DESCRIPTION OF THE DRAWINGS

FIG. 1A is a diagram illustrating a time-series forecasting method of a transformer model in which one observation corresponds to one token according to an embodiment of the present disclosure.

FIG. 1B is a diagram illustrating a time-series forecasting method of a segment-based transformer model according to an embodiment of the present disclosure.

FIG. 2 is a schematic block diagram of an efficient segment-based sparse transformer (ESSformer) according to an embodiment of the present disclosure.

FIG. 3 is a flowchart illustrating a method of generating prediction data according to an embodiment of the present disclosure.

FIG. 4 is a table showing the performance of the ESSformer block according to an embodiment of the present disclosure.

FIG. 5 is a block diagram of a device of generating prediction data according to an embodiment of the present disclosure.

### DETAILED DESCRIPTION OF EXEMPLARY EMBODIMENTS

In order to clarify the technical spirit of the present disclosure, embodiments of the present disclosure will be described in detail with reference to the accompanying drawings. In describing the present disclosure, when it is determined that the detailed description of a related known function or component may unnecessarily obscure the gist of the present disclosure, the detailed description thereof will be omitted. In the drawings, components having substantially the same function or configuration are given the same reference numerals and symbols as possible even when they are shown in different drawings. For convenience of explanation, an apparatus and method will be described together when necessary. Each operation of the present disclosure does not necessarily need to be performed in the order described, and may be performed in parallel, selectively, or individually.

Terms used in the embodiments of the present disclosure were selected as general terms widely used at present as possible while considering functions of the present disclosure, but these terms may vary depending on the intention of those skilled in the art, legal precedents, the emergence of new technologies, or the like. In addition, in specific cases, there are terms arbitrarily selected by the applicant, and in this case, the meanings thereof will be described in detail in the description of the corresponding embodiment. Therefore, terms used in the present specification should be defined based on the meanings of the terms and the overall contents of the present disclosure rather than just the names of the terms.

Throughout the present disclosure, singular expressions may include plural expressions unless the context explicitly states otherwise. It should be understood that terms such as “comprise” or “have” are intended to specify the presence of a feature, number, step, operation, component, part, or a combination thereof, but do not preemptively preclude the possibility of the presence or addition of one or more other features, numbers, steps, operations, components, parts, or combinations thereof. That is, throughout the present disclosure, when a certain portion is described as “including,” a certain component, it means further including another component rather than precluding another component unless especially stated otherwise.

Expressions such as “at least one” modify the entire list of components, and do not individually modify components of the list. For example, “at least one of A, B, and C” or “at least one of A, B, or C” refers to only A, only B, only C, both A and B, both B and C, both A and C, all of A, B, and C, or a combination thereof.

In addition, terms such as “ . . . unit,” “ . . . module”, etc. described in the present disclosure mean a unit that process at least one function or operation, which may be implemented as hardware, such as a processor, controller and memory, or software, or a combination of hardware and software.

Throughout the present disclosure, when a certain portion is described as being “connected” to another portion, it includes not only a case where the certain portion is “directly connected” to another portion, but also a case where the certain portion is “indirectly connected”, “operably connected”, or “electrically connected” to another portion with another element interposed therebetween. In addition, when a certain portion is described as “including” a certain component, it means further including another component rather than precluding another component unless specifically stated otherwise.

The expression “configured to (or set to)” as used throughout the present disclosure may, depending on the contexts, be used interchangeably with, for example, “suitable for,” “having the capacity to,” “designed to,” “adapted to,” “made to,”, “shaped to” or “capable of.” The term “configured to (or set to)” does not necessarily mean only “specifically designed to” in hardware. Instead, in certain contexts, the expression “a system configured to” may mean that the system is “capable of” in conjunction with other apparatuses or parts. For example, the phrase “a processor configured to (or set to) perform A, B, and C” may mean a dedicated processor (e.g., an embedded processor) for performing corresponding operations, or a generic-purpose processor (e.g., a CPU or application processor) that can perform corresponding operations by executing one or more software programs stored in a memory.

Throughout the present disclosure, the notation [N: M] denotes a set of integers from N to M, where N is included and M is not included. That is, [N: M] may mean {N, N+1, . . . , M−1}.

Time-series forecasting may be a fundamental machine learning task performed to predict future events based on past observations. The prediction operation may often require long-term prediction and involve multiple variables. For example, stock price prediction may require the estimation of multiple market values over a long time axis. In the multivariate long-term time-series forecasting (M-LTSF), it may be important to capture both long-term temporal dependencies between past and future events and inter-feature dependency among a plurality of different variables.

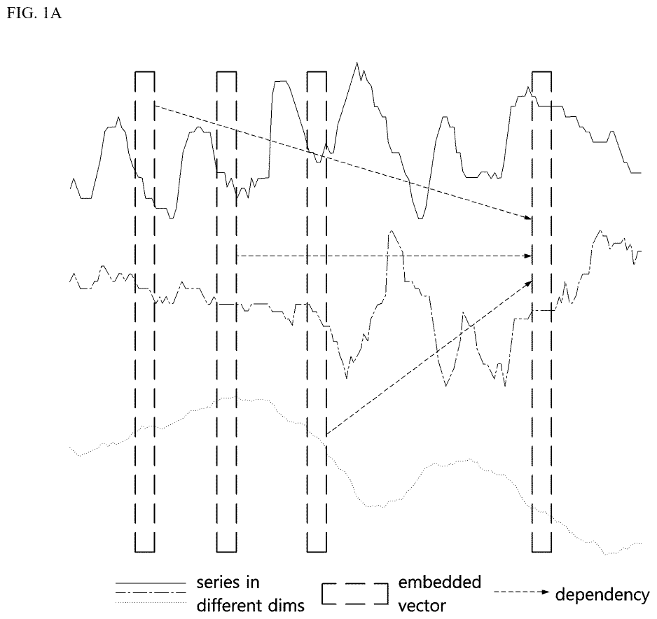

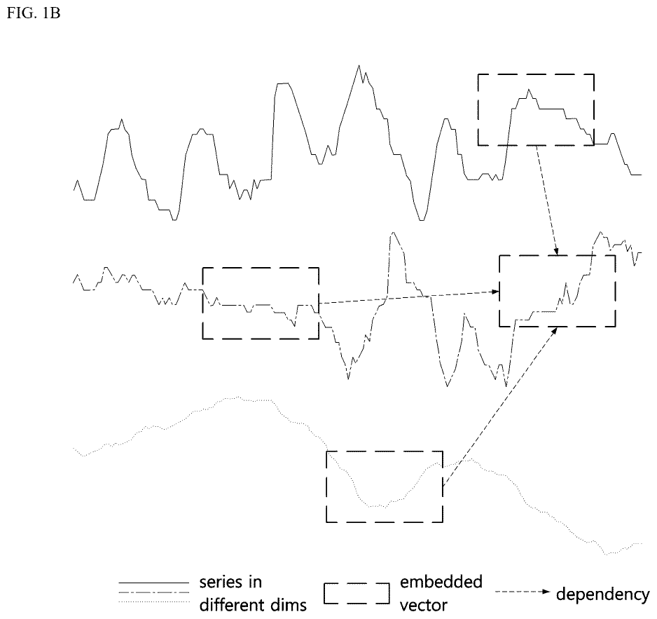

In recent years, many deep neural architectures such as a linear model, a state-space model, and a recurrent neural network (RNN) have been developed for resolving the problems of the M-LTSF. Among them, a transformer model is a neural network that learns context and semantics by tracking relationships in sequential data such as words in a sentence and has demonstrated remarkable performance in various domains such as language and image processing, and due to the ability of the transformer model to capture long-term relationships, the transformer model has also been studied in the field of the M-LTSF. For example, as illustrated in FIG. 1A, a transformer model in which one observation corresponds to one token is used in the field of time-series forecasting. In recent studies, as illustrated in FIG. 1B, a segment-based transformer model, in which each token is represented as a group of consecutive observations rather than a single observation, has been proposed. However, in the segment-based transformer model employing self-attention, one segment corresponds to one token, and as the segments are further subdivided or more segmented, the prediction performance may improves, but it also leads to a rapid increase in the number of tokens, resulting in a significant increase in the computational cost associated with the attention operation. In addition, as illustrated in FIG. 1B, in inter-feature attention that finds correlation between features, when the number of features is very large, the operation of prediction may be performed inefficiently. In order to address these problems, an embodiment of the present disclosure may provide a time-series forecasting method that can maintain prediction performance while employing reduced or less segmentation and also achieve efficient and stable prediction performance even when performing inter-feature attention across a large number of features. A transformer model provided by one embodiment of the present disclosure may be referred to as an efficient segment-based sparse transformer (ESSformer).

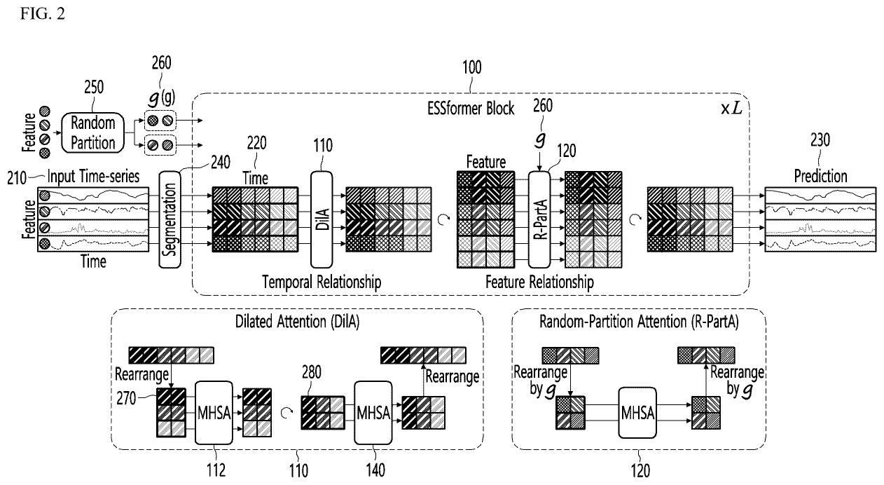

FIG. 2 is a schematic block diagram of an efficient segment-based sparse transformer (ESSformer) according to an embodiment of the present disclosure.

Referring to FIG. 2, a dimension-segment-wise (DSW) embedding may be performed in order to process past time-series information. In the DSW embedding, each individual dimensional time series may be divided or partitioned into segments and then embedded into feature vectors. An output of the DSW embedding may be a 2D vector matrix having time and dimension as two axes. In order to efficiently capture cross-temporal and cross-dimensional dependency between the vector matrices, two stages of attention layers may be used.

In one embodiment, an ESSformer block 100 may include sparse attention modules customized for the segment-based transformer. In one embodiment, the ESSformer block 110 may include a dilated attention (DilA) module 110, configured to learn interactions between periodically distant segments to efficiently capture temporal dependency, and a random-partition attention (R-PartA) module 120, configured to capture inter-feature dependency. For instance, the DilA module 110 may be an attention module in a temporal dimension, and the R-PartA module 120 may be an attention module in a feature dimension. That is, the DilA module 110 may be a model configured to efficiently learn temporal dependency, and the R-PartA module 120 may be a model configured to efficiently learn inter-feature dependency.

Hereinafter, some embodiments of the ESSformer block 100 will be described in more detail.

In one embodiment, the DilA module 110 may be configured to perform dilated attention with a stride P and block-diagonal attention with a block size P based on periodic patterns appearing in a self-attention matrix of the segment-based transformer. Through this, when the number of segments N_{S} is given as an input, the computational cost in the temporal attention layer may be reduced from

$$O ( {N}_{S}^{2} ) to O ( {N}_{S}^{1.5} ) .$$

In one embodiment, the R-PartA module 120 may be configured to randomly partition features into groups of equal size S_{G} and mask attention matrices between different groups, in order to capture various inter-feature dependencies. Through this configuration of the R-PartA module 120, when a feature size is D, the attention computation cost may be reduced from O(D²) to O(DS_{G}). According to one embodiment, the stochasticity inherent in the random partition of the R-PartA module 120 may enable efficient and effective learning. In addition, according to one embodiment, a limitation in which inter-feature relationships are not be fully captured as a result of masked attention may be addressed by using a test-time ensemble technique in the inference stage.

In one embodiment, a D-variable time-series observation xₜ at time t may be represented as, {x_{t,d}∈R|d∈[0D]}∈R^{d}, where x_{t,d} denotes an observation of an actual value of a d-th feature at time t. The time-series forecasting may predict future observations {xₜ}_{t∈[T,T+τ]} based on previous observations {xₜ}_{t∈[0,T]}. Here, T denotes the length of past time steps, and τ denotes the length of future time steps. One embodiment of the present disclosure can provide an efficient time-series forecasting method in cases of multivariate long-term time-series forecasting, where D>1 and τ>>1.

In one embodiment, multivariate time-series observations {x_{t,d}}_{t∈[0:T]}, d∈[0:D] may be divided into N_{S} segments of equal length. That is, the b-th segment of the d-th feature may be represented as set forth in Equation 1 below.

$${s}_{b , d} = \{ {x}_{t , d} ∈ R \vert t ∈ [ \frac{bT}{{N}_{S}} : \frac{( b + 1 ) T}{{N}_{S}} ] \} ∈ {R}^{\frac{T}{{N}_{s}}} \qquad [ Equation 1 ]$$

In one embodiment, observations may be embedded into a latent space through a linear layer, and a trainable temporal encoding E^{Time}∈R^{N}^{ₛ}^{×d}^{ₕ} and a feature-specific positional encoding E^{Feat}∈R^{D×d}^{ₙ} may be added, thereby representing the input as set forth in Equation 2 below.

$${H}_{b , d}^{( 0 )} = Linear ( {s}_{b , d} ) + {E}_{b}^{Time} + {E}_{d}^{Feat} ∈ {R}^{{d}_{h}} , {H}^{( 0 )} ∈ {R}^{{N}_{S} \times D \times {d}_{h}} \qquad [ Equation 2 ]$$

When an initial representation H⁽⁰⁾ is given as input, a segment-based transformer encoder having L layers may output a final representation H^{(L)}, and the output H^{(L)} may be provided through a decoder to predict future observations.

In one embodiment, by using a linear-based decoder,

$${\{ {H}_{b , d}^{( L )} \}}_{b = 1}^{{N}_{S}}$$

may be mapped to future observation {x_{t,d}}_{t∈[T,T+τ]} by a single linear layer.

Hereinafter, based on the above representations, the ESSformer according to one embodiment of the present disclosure will be described. In one embodiment, when an input segment representation H⁽⁰⁾ is given, each layer of the ESSformer may be represented as set forth in Equations 3 and 4 below.

$${\overline{H}}^{( ℓ - 1 )} = {H}^{( ℓ - 1 )} + R - PartA ( {H}^{( ℓ - 1 )} , DilA ( {H}^{( ℓ - 1 )} ) ) \qquad [ Equation 3 ]$$

$${H}^{( ℓ )} = {\overline{H}}^{( ℓ - 1 )} + MLP ( {\overline{H}}^{( ℓ - 1 )} ) , ℓ = 1 , … , L \qquad [ Equation 4 ]$$

The DilA module 110 will be described in further detail below. In one embodiment, in order to capture temporal relationships from input segments H∈R^{N}^{ₛ}^{×D×d}^{ₕ}, the DilA module 110 processes the input through two attention modules 112 and 140, each of which may discover separate temporal relationships. In one embodiment, the attention modules 112 and 140 may be multi-head self-attention (MHSA) modules. For intra-period relationships, the block-diagonal attention module 112 having the block size P may mix features between segments in the same time period. In addition, for inter-period relationships, the dilated attention module 140 having stride P may share representations between periodically distant segments for longer-range contextualization.

Here, Q, K, and V denote query, key, and value, respectively, and MHSA (Q, K, V) is assumed to represent a vanilla MHSA layer. When a set of numbers C is given as an index, it may be defined as selecting all indices included in C (e.g., H_{C,d}={H_{b,d}}_{b∈C}∈R^{|C|×d}^{ₕ}). The stepwise procedure of the DilA module 110 may be represented as set forth in Equations 5 and 6 below.

$$∀ i ∈ [ 0 : \frac{T}{P} ] , {{\tilde{V}}^{DilA} ( H )}_{[ iP : ( i + 1 ) P ] , d} = M H S A ( {H}_{[ iP : ( i + 1 ) P ] , d} , {H}_{[ iP : ( i + 1 ) P ] , d} , {H}_{[ iP : ( i + 1 ) P ] , d} ) \qquad [ Equation 5 ]$$

$${∀}_{J} ∈ [ 0 : P ] , DilA {( H )}_{[ j : : P ] , d} = M H S A {( H )}_{[ j : : P ] , d} , {( H )}_{[ j : : P ] , d} , {\tilde{V}}^{DilA} {( H )}_{[ j : : P ] , d} ) \qquad [ Equation 6 ]$$

Here, [j::P] denotes an index set starting from j with the stride P. That is, [j::P]:={j, j+P, j+2P, . . . }. In one embodiment, the block-diagonal attention module 112 may capture the intra-period relationships according to Equation 5, and the inter-period relationships may be considered according to Equation 6.

If the DilA module 110 is not used, the computational cost of

$$O ( {N}_{S}^{2} )$$

is required to encode N_{S} segments through self-attention. This may become difficult to handle when dealing with time-series data with a large T. Although increasing the duration of each segment may reduce N_{S}, in transformer-based generative modeling, lower segment granularity may lead to reduced inference quality. Accordingly, considering that time-series forecasting is similar to generating future observations conditioned on past signals, an efficient architecture with quadratic asymptotic cost with respect to the number of segments is required. To address this issue, the DilA module 110 according to one embodiment may effectively apply block-diagonal and stride sparse attention masks, thereby reducing computational cost without significantly compromising the expressiveness of self-attention.

A periodically dilated sparse structure according to one embodiment is proposed based on the graphs depicting attention score matrices of various transformer models after training on the M-LTSF. In one embodiment, since the period is

$$P *= {2}^{⌈ {log}_{2} \sqrt{{N}_{s}} ⌉} \approx \sqrt{{N}_{s}} ,$$

time and memory complexity may be reduced from

$$O ( {N}_{S}^{2} ) to O ( {N}_{S}^{1.5} ) .$$

Periodically sparse attention using P* may be sufficient to maintain the downstream functionality of full attention.

The R-PartA module 120 will be described in further detail below. A segment-based transformer for M-LTSF may tokenize each feature individually and model interactions between features in addition to temporal contextualization, thereby enhancing downstream performance. However, is the use of full attention results in a computational cost of O(D²), and accordingly, may make it difficult to handle a large number (D) of features. In one embodiment, in order to reduce the cost for D, the R-PartA module 120 may first randomly partition D features into N_{G} separate groups { [symbol] (g)}_{g∈[0:N}_{_{G}}]. Here, the separate groups may all have equal size S_{G}, where may be | [symbol] (g)|=S_{G′}∩_{g∈[0:N}_{_{G]}} [symbol] (g)=φ and ∀_{g∈[0:N}_{_{G]}} [symbol] (g)=[0:D]. In one embodiment, a single partition may be sampled before each forward step and used across the entire layers of the transformer model. Then, the R-PartA module 120 may mix the inter-feature representations in the same group through the block-diagonal attention according to Equation 6.

$${∀}_{g} ∈ [ 0 : {N}_{G} ] , R - PartA {( H , V )}_{b , 𝒢 ( g )} = M H S A ( {H}_{b , 𝒢 ( g )} , {H}_{b , 𝒢 ( g )} , {V}_{b , 𝒢 ( g )} ) \qquad [ Equation 6 ]$$

Since this operation considers only intra-group interactions, the computational cost may be reduced from O(D²) to O(DS_{G}). However, if the prediction procedure is executed only once in the inference stage, only partial inter-feature information in each group may be considered. To address the limitation that not all information is not utilized, a test-time ensemble method may execute the prediction procedure by randomly partitioning the N_{E} time and ensemble or aggregate (e.g., average) prediction outputs of N_{E}. The ensemble procedure may be performed according to Algorithm 1 below.

[Algorithm 1]
Algorithm 1: Training & inference of ESSformer

```
Input: # of features D, # of layers L, # of groups N_{G}, # of test-time
  ensembling N_{E}. Length of a period in [symbol] -th layer [symbol] , Past
  $observations X = {\{ {X}_{d} \}}_{d = 1}^{D}$
N_{E} = N_{E} if is_inference then else 1;
F = [0 : D];
for i ← 1 to N_{E} do [symbol]
  = { [symbol]  (g)}_{g∈[0: N}_{_{G}}] = Random_Partition(F);
  H⁽⁰⁾ = Segmentation(X);
  for [symbol]   ← 1 to L do [symbol]
    = ESSformer- [symbol]   ( [symbol]  , [symbol] , [symbol]  );
  ${Y}_{d}^{i} = Linear ( Concat ( {\{ {H}_{b , d}^{( L )} \}}_{b ∈ [ 0 : {N}_{S} ]} ) ) ;$
  ${Y}^{i} = {\{ {Y}_{d}^{i} \}}_{d ∈ [ 0 : D ]}$
Y = (Y¹ + Y² + ... + Y^{N}^{_{E}})/N_{E};
return Predicted future observations Y;
```

According to one embodiment of the present disclosure, the R-PartA module 120 may reduce the computational cost as well as improve the prediction performance.

In the description with reference to FIG. 2, the ESSformer block 100 is described as an example using both the DilA module 110 and the R-PartA module 120; however, the present disclosure is not limited thereto, and a configuration including only one of the DilA module 110 or the R-PartA module 120 may be implemented.

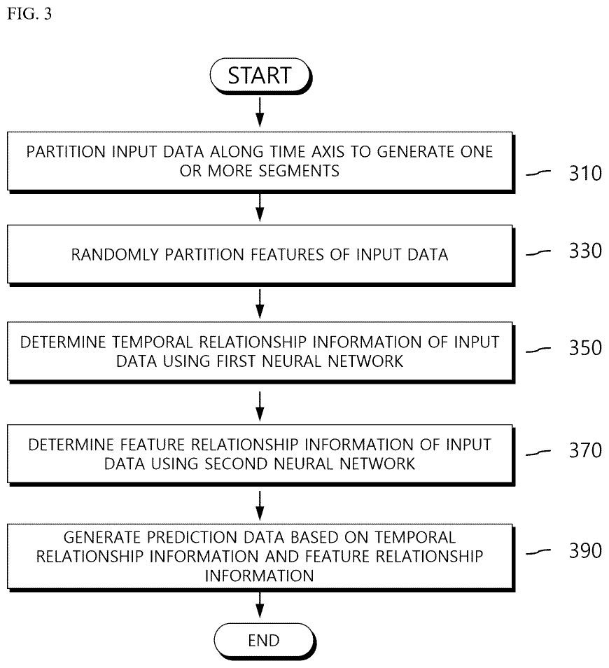

FIG. 3 is a flowchart illustrating a method of generating prediction data according to an embodiment of the present disclosure.

Referring to FIGS. 2 and 3, in operation 310, input data is partitioned along time axis to generate one or more segments. In one embodiment, the input data may include input time-series data 210 in FIG. 2. The input time-series data 210 may be multivariate time-series data. The input data may be segmented along time axis to generate an input sequence or input segments 220. Therefore, a system for generating prediction data 230 may include a segmentation module 240 for partitioning the input data along time axis to generate one or more segments. The ESSformer block 100 according to one embodiment of the present disclosure may include a neural network for generating the prediction data 230 using the input sequence 220. The segmentation module 240 may not be included in the ESSformer block 100 as illustrated in FIG. 2. Alternatively, the segmentation module 240 may be comprised in the ESSformer block 100.

In operation 330, features of the input data are randomly partitioned. In FIG. 3, operation 330 is illustrated as being performed between operation 310 and operation 350, but this ordering is merely illustrative, and operation 330 may be performed in any order provided that it is performed before operation 370. For example, operation 330 can be performed before operation 310 or between operation 350 and operation 370.

In one embodiment, the system for generating prediction data 230 may include a random partition module 250 configured to randomly partition features of the input data. In one embodiment, partition information 260 of the features partitioned by the random partition module 250 may be utilized when a second neural network for extracting inter-feature dependency is used.

In one embodiment, the random partition module 250 may not be included in the ESSformer block 100 as illustrated in FIG. 2. Alternatively, the random partition module 250 may be comprised in the ESSformer block 100. For example, when the random partition module 250 and the segmentation module 240 are not comprised in the ESSformer block 100, the ESSformer block 100 may receive the partition information 260 of features and the segmented input sequence 220 as inputs from the random partition module 250 and the segmentation module 240 and may use the inputs to generate the prediction data 230.

In operation 350, temporal relationship information of the input data is determined using a first neural network. The first neural network may include a neural network configured to apply dilated attention to the input sequence segmented along time axis.

In one embodiment, at least one processor configured to perform the method of generating the prediction data may rearrange the segmented input sequence based on a predetermined period and may perform multi-head self-attention (MHSA) on the rearranged data. Here, the predetermined period may be set based on

$$P *= {2}^{⌈ {log}_{2} \sqrt{{N}_{s}} ⌉} \approx \sqrt{{N}_{s}} .$$

For example, as illustrated in FIG. 2, when six segments are present, the segments may be sequentially identified, starting from the beginning, as segment #0, segment #1, . . . , segment #5. In this example, the predetermined period may be set to \sqrt{6}≈2.44≈2. Accordingly, at least one processor may rearrange the input sequence by splitting the input sequence for each period. Accordingly, first rearranged data 270 may be rearranged as {segment #0, segment #1}, {segment #2, segment #3}, {segment #4, segment #5}. The first MHSA 112 may be applied to the first rearranged data 270 to extract dependency along time axis. However, since it may be difficult to capture dependencies between distant segments, at least one processor may rearrange the input sequence by grouping segments that are spaced by the predetermined period. Accordingly, second rearranged data 280 may be rearranged as {segment #0, segment #2, segment #4}, {segment #1, segment #3, segment #5}. At least one processor may identify dependencies between the segments that are spaced by the predetermined period using the second MHSA 140 for the second rearranged data 280. That is, the first neural network may include the MHSA module 112 configured to extract features between segments in the same time period, and the second MHSA module 140 configured to extract features between periods of segments that are periodically spaced, based on rearrangement of the input sequence segmented along time axis for each feature.

In one embodiment, temporal relationship information of the input data may be determined by the first neural network. According to one embodiment, prediction performance may be maintained without extracting all temporal dependencies between all segments, but instead by extracting temporal dependencies between consecutive segments in the period and temporal dependencies between segments that are spaced by the period. That is, according to one embodiment, the dependencies between consecutive segments and the dependencies between segments that are spaced by the predetermined period may be extracted, thereby maintaining prediction performance while reducing computational complexity.

In operation 370, feature relationship information of the input data is determined using the second neural network. In one embodiment, the second neural network may include a neural network configured to apply random partition attention to data arranged along a feature axis. The second neural network may use data in which output data of the first neural network are arranged along a feature axis, or may use data in which the segmented input sequence is arranged along a feature axis.

In one embodiment, the second neural network may include a third MHSA module configured to extract inter-feature dependencies based on rearrangement of features of the input data according to the partition information 260 determined by the random partition module 250. For example, when there are four features—namely feature #1, feature #2, feature #3, and feature #4—are provided in an order from top to bottom, and the partition information 260 specifies groups {feature #4, feature #2} and {feature #3, feature #1} as illustrated in FIG. 2, at least one processor may generate third rearranged data by rearranging data aligned along a feature axis into groups {feature #4, feature #2} and {feature #3, feature #1}. In addition, at least one processor may apply the MHSA to the third rearranged data, and then rearrange the resulting data based on the partition information 260 to restore the original feature order. Through this, at least one processor may determine feature relationship information of the input data using the second neural network.

In operation 390, the prediction data is generated based on the temporal relationship information and the feature relationship information. In one embodiment, the prediction data may be generated based on the temporal relationship information determined using the first neural network and the feature relationship information determined using the second neural network. That is, at least one processor may generate the prediction data by processing the input sequence segmented along a time axis using the neural networks.

In one embodiment, at least one of the first neural network and the second neural network may include the sparse attention module.

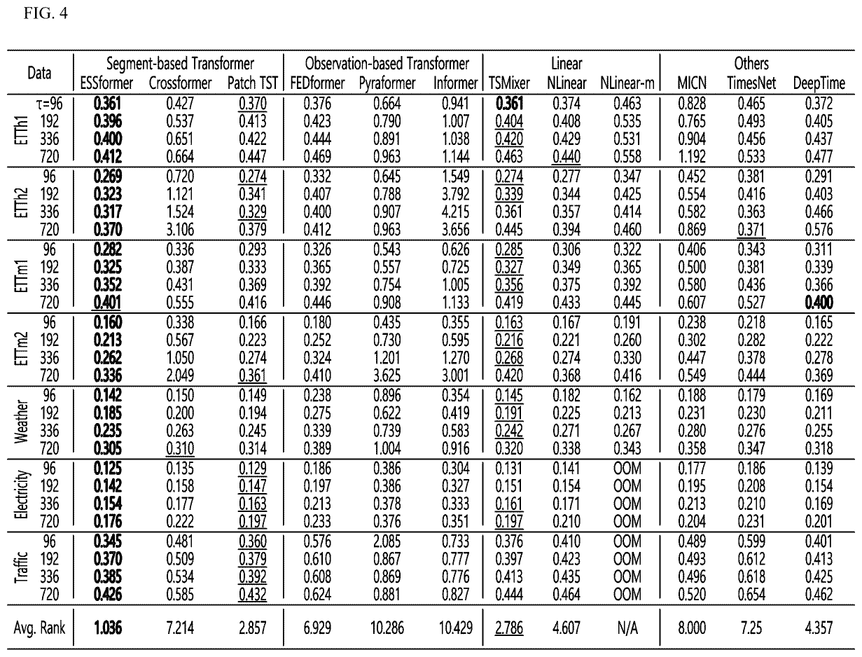

FIG. 4 is a table showing performance of the ESSformer block according to an embodiment of the present disclosure.

Referring to FIG. 4, the ESSformer method according to an embodiment of the present disclosure achieves the most efficient computational complexity among various segment-based transformers. For example, the table of FIG. 4 shows that the ESSformer according to an embodiment of the present disclosure achieved the best performance in 27 out of 28 tasks of M-LTSF, and ranked second in the remaining one task. Therefore, the ESSformer method according to an embodiment of the present disclosure may not only reduce computational complexity but also improve prediction performance.

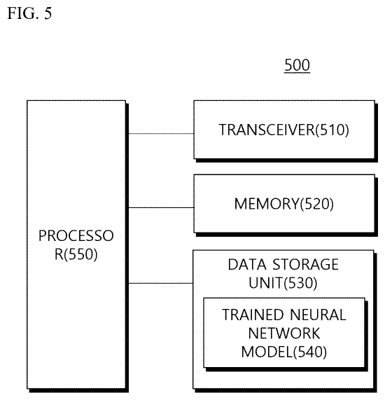

FIG. 5 is a block diagram of a device of generating prediction data according to an embodiment of the present disclosure.

Referring to FIG. 5, a device 500 of generating prediction data (also referred to as a server or a system) may include one or more of a transceiver 510, a memory 520, a data storage unit 530, or a processor 550. However, not all of the components illustrated in FIG. 5 are essential components of the prediction data generation device 500. One or more of the components illustrated in FIG. 5 may be omitted or combined. The device 500 may be implemented with additional components other than those illustrated in FIG. 5. In addition, the transceiver 510, the memory 520, and the processor 550 may be implemented in the form of a single integrated chip or multiple chips.

In an embodiment, the transceiver 510 may communicate with a terminal or other electronic devices connected to the device 500 via a wired or wireless communication.

Various types of data, such as programs including applications and files, may be installed and/or stored in the memory 520. The processor 550 may access data stored in the memory 520 and retrieve or use the data, or may store new data in the memory 520. In addition, the memory 520 may store one or more instructions. The processor 550 may execute one or more instructions stored in the memory. The memory 520 may store information. For example, the memory 520 may include one or more of a non-transitory computer-readable medium, a volatile memory unit, or a non-volatile memory unit.

Functions or operation for artificial intelligence according to some embodiments of the present disclosure may be operated or performed by the processor 550 and the memory 520. The processor 550 may include one or a plurality of processors. One or plurality of processors may be a general-purpose processor such as a central processing unit (CPU), an application Processor (AP), or a digital signal processor (DSP), a graphics-dedicated processor such as a graphics processing unit (GPU) or a vision processing unit (VPU), or an artificial intelligence-dedicated processor such as a neural processing unit (NPU). One or plurality of processors may control input data to be processed according to a predefined operation rule or an artificial intelligence model that are stored in the memory 520. Alternatively, when the one or plurality of processors are artificial intelligence-dedicated processors, the artificial intelligence-dedicated processor may be designed with a hardware structure specialized for processing a specific artificial intelligence model.

In one embodiment, the data storage unit 530 may provide a large-scale storage for the prediction data generation device 500. For example, the data storage unit 530 may be a non-transitory computer-readable medium. Alternatively, the data storage unit 530 may include a hard disk device, an optical disk device, a storage device shared via a network by a plurality of computing devices (e.g., a cloud storage device), or some other mass storage device. The data storage unit 530 may include a trained neural network model 540.

The processor 550 may control the overall operation of the device 500 and may include at least one processor such as a CPU, a GPU, and the like. The processor 550 may control other components included in the device 500 to perform operations for operating the device 500. For example, the processor 550 may generate prediction data by processing an input sequence segmented along time axis using a neural network, by executing one or more instructions.

One embodiment of the present disclosure may also be implemented in the form of a recording medium including computer-executable instructions such as program modules executed by a computer. A non-transitory computer-readable medium may be any available medium that can be accessed by the computer, and may include all of volatile and non-volatile media, and removable and non-removable media. In addition, the non-transitory computer-readable medium may include both computer storage media and communication media. The computer storage media may include all of volatile and non-volatile, removable and non-removable media that are implemented in any method or technology for storage of information such as computer-readable instructions, data structures, program modules, or other data. The communication media typically include computer-readable instructions, data structures, or program modules and includes any information delivery media.

According to one embodiment of the present disclosure, prediction data having efficiency and high accuracy can be determined by using multivariate long-term time-series input data.

The above description of the present disclosure is for illustrative purposes, and those skilled in the art to which the present disclosure pertains will understand that various modifications can be easily made into other specific forms without departing from the technical spirit or essential characteristics of the present invention. Therefore, it should be understood that the above-described embodiments are illustrative and not restrictive in all respects. For example, each component described in a singular form may be implemented separately, and likewise, components described as being implemented separately may also be implemented in a combined form.

The scope of the present disclosure is defined by the claims described below rather than the above detailed description, and all changes or modifications derived from the meaning and scope of the claims and their equivalent concepts should be construed as being included within the scope of the present disclosure.

What is claimed is:

1. A system comprising:
at least one memory configured to store one or more executable instructions; and
at least one processor configured to generate prediction data by processing an input sequence segmented along a time axis based on a predetermined period using neural networks,
wherein the neural networks comprise:
a first neural network configured to apply dilated attention to the input sequence segmented along the time axis based on the predetermined period; and
a second neural network configured to apply random partition attention to data arranged along a feature axis, and
wherein the at least one processor is configured to execute one or more of the instructions to perform operations comprising:
determining temporal relationship information of input data using the first neural network;
determining feature relationship information of the input data using the second neural network; and
generating the prediction data based on the temporal relationship information determined by the first neural network and the feature relationship information determined by the second neural network.

2. The system of claim 1, wherein at least one of the first neural network and the second neural network comprises a sparse attention module.

3. The system of claim 1, further comprising a segmentation module configured to partition the input data along the time axis to generate segments.

4. The system of claim 1, wherein the first neural network comprises:
a first multi-head self-attention (MHSA) module configured to extract features between consecutive segments in the predetermined period, based on rearrangement of the input sequence segmented along the time axis for each of the features; and
a second MHSA module configured to extract features between periods of segments periodically spaced by the predetermined period.

5. The system of claim 4, wherein the predetermined period is set using
$$P *= {2}^{⌈ {log}_{2} \sqrt{{N}_{s}} ⌉} \approx \sqrt{{N}_{s}} ,$$
where a number of the segments is N_{S}.

6. The system of claim 1, further comprising a random partition module configured to randomly partition features of the input data,
wherein the second neural network comprises a third multi-head self-attention (MHSA) module configured to extract inter-feature dependencies based on rearrangement of the features of the input data according to arrangement determined by the random partition module.

7. A computerized method comprising:
generating, by at least one processor, prediction data by processing an input sequence segmented along a time axis using neural networks,
wherein the neural networks comprise:
a first neural network configured to apply dilated attention to the input sequence segmented along the time axis; and
a second neural network configured to apply random partition attention to data arranged along a feature axis based on output data of the first neural network, and
wherein the generating of the prediction data comprises:
determining temporal relationship information of input data using the first neural network;
determining feature relationship information of the input data using the second neural network; and
generating the prediction data based on the temporal relationship information determined by the first neural network and the feature relationship information determined by the second neural network.

8. The computerized method of claim 7, wherein
at least one of the first neural network and the second neural network comprises a sparse attention module.

9. The computerized method of claim 7, further comprising partitioning the input data along the time axis to generate segments.

10. The computerized method of claim 7, wherein the first neural network comprises:
a first multi-head self-attention (MHSA) module configured to extract features between consecutive segments in a predetermined period, based on rearrangement of the input sequence segmented along the time axis for each of the features; and
a second MHSA module configured to extract features between periods of segments periodically spaced by the predetermined period.

11. The computerized method of claim 10, wherein
the predetermined period is set using
$$P *= {2}^{⌈ {log}_{2} \sqrt{{N}_{s}} ⌉} \approx \sqrt{{N}_{s}} ,$$
where a number of segments is N_{S}.

12. The computerized method of claim 7, further comprising randomly partitioning features of the input data,
wherein the second neural network comprises a third multi-head self-attention (MHSA) module configured to extract inter-feature dependencies based on rearrangement of the features of the input data according to arrangement determined by the random partition module.

13. A non-transitory computer-readable medium encoding instructions which, when executed, cause one or more processors to perform operations comprising:
generating prediction data by processing an input sequence segmented along a time axis based on a predetermined period using neural networks,
wherein the neural networks comprise:
a first neural network configured to apply dilated attention to the input sequence segmented along the time axis based on the predetermined period; and
a second neural network configured to apply random partition attention to data arranged along a feature axis based on output data of the first neural network, and
wherein the generating of the prediction data comprises:
determining temporal relationship information of input data using the first neural network;
determining feature relationship information of the input data using the second neural network; and
generating the prediction data based on the temporal relationship information determined by the first neural network and the feature relationship information determined by the second neural network.

14. The non-transitory computer-readable medium of claim 13, wherein at least one of the first neural network and the second neural network comprises a sparse attention module.

15. The non-transitory computer-readable medium of claim 13, wherein the operations further comprise partitioning the input data along the time axis to generate segments.

16. The non-transitory computer-readable medium of claim 13, wherein the first neural network comprises:
a first multi-head self-attention (MHSA) module configured to extract features between consecutive segments in the predetermined period, based on rearrangement of the input sequence segmented along the time axis for each of the features; and
a second MHSA module configured to extract features between periods of segments periodically spaced by the predetermined period.

17. The non-transitory computer-readable medium of claim 16, wherein
the predetermined period is set using
$$P *= {2}^{⌈ {log}_{2} \sqrt{{N}_{s}} ⌉} \approx \sqrt{{N}_{s}} ,$$
where a number of segments is N_{S}.

18. The non-transitory computer-readable medium of claim 13, wherein:
the operations further comprise randomly partitioning features of the input data, and
the second neural network comprises a third multi-head self-attention (MHSA) module configured to extract inter-feature dependencies based on rearrangement of the features of the input data according to arrangement determined by the random partition module.
